(19) United States
(12) Patent Application Publication
(10) Pub. No.: US 2017/0222820 A1
(43) Pub. Date: Aug. 3, 2017

(54) COLLABORATIVE POLICY MANAGEMENT STRATEGIES AT A MOBILE DEVICE

(71) Applicant: Seven Networks, LLC, Marshall, TX (US)

(72) Inventors: Ari Backholm, Los Altos, CA (US); Vivek Agarwal, Foster City, CA (US); Alexander Ren, San Carlos, CA (US); Ankur Gupta, San Carlos, CA (US); Ross Bott, Half Moon Bay, CA (US)

(21) Appl. No.: 15/488,827

(22) Filed: Apr. 17, 2017

Related U.S. Application Data
(63) Continuation of application No. PCT/US15/56132, filed on Oct. 18, 2015.
(60) Provisional application No. 62/110,457, filed on Jan. 30, 2015.
(60) Provisional application No. 62/087,927, filed on Dec. 5, 2014.
(60) Provisional application No. 62/065,105, filed on Oct. 17, 2014.

(51) Int. Cl. H04L 12/14; H04M 15/00; H04W 24/02

(52) U.S. Cl. CPC H04L 12/1403; H04W 24/02; H04M 15/80; H04M 15/61

(57) ABSTRACT

A method is provided. The method includes electing a mobile device optimization strategy at a mobile device, web interface, or through direction to the provider. In exchange for a user selecting the mobile device optimization strategy, a network or service provider provides one or more plan-related incentives. A related system and mobile device are also disclosed.

### CROSS REFERENCE TO RELATED APPLICATION

This application is a continuation application of PCT Patent Application No. PCT/US15/56132 entitled “COLLABORATIVE POLICY MANAGEMENT STRATEGIES AT A MOBILE DEVICE”, (Attorney Docket No. 455-196 PCT) which was filed on Oct. 18, 2015, which claims benefit of and priority to U.S. Provisional Patent Application No. 62/065,105 entitled “User Configurable Optimization Strategies at a Mobile Device based on Data Requested by the Mobile Device,” (Attorney Docket No. 455-196 PROV) which was filed on Oct. 17, 2014, U.S. Provisional Patent Application No. 62/087,927 entitled “Collaborative Policy Management Strategies at a Mobile Device,” (Attorney Docket No. 455-196-2 PROV) which was filed on Dec. 5, 2014, and U.S. Provisional Patent Application No. 62/110,457 entitled “Collaborative Policy Management Strategies at a Mobile Device with Offloading,” (Attorney Docket No. 455-196-3 PROV) which was filed on Jan. 30, 2015, the contents of each of which are incorporated by reference herein.

### BACKGROUND

Field of the Invention

The present invention relates to policy management, and more specifically, to collaborative policy management strategies at a mobile device.

Description of Related Art

Applications are changing the industry as carriers and handset manufacturers, both, are seeking partnerships with application and content providers to differentiate their products and services. For the network, this can only mean more signaling and bandwidth challenges, on top of the unsolved problems of today. The 4G/LTE network roll out is expected to help with added bandwidth, but it may lead users to use more data neutralizing that benefit. For signaling, 4G/LTE won't be a fix for a number of reasons including the flat network design and the fact that the only devices on a 4G network are Smart phones.

As mobile device usage increases, carriers have begun implementing limits on the amount of data that a user may request in any given billing cycle. Overage charges can be significant for the user and users are anxious about the overage charges. Additionally, even many unlimited plans have a soft cap range at which data throttling occurs at many users would prefer to avoid soft cap and associated throttling if possible.

Accordingly, a need exists for one or more methods and systems are provided herein to address these issues.

### BRIEF SUMMARY

According to one embodiment of the present invention, a method includes electing a mobile device optimization strategy at a mobile device, web interface, or through direction to the provider. In exchange for a user selecting the mobile device optimization strategy, a network or service provider provides one or more plan-related incentives. A related system and mobile device are also disclosed

According to another embodiment of the present invention, a system includes a mobile device and a server communicating with the mobile device. The mobile device includes a processor coupled to a memory unit, the memory unit having instructions stored thereon, which when executed by the processor, causes the processor to execute optimization strategies defined by a user at the mobile device. The optimization strategies include providing, by a network or service provider, one or more plan-related incentives in exchange for a user selecting the mobile device optimization strategy. The server is configured for optimizing data requested by the mobile device according to the optimization strategy executing on the mobile device.

### BRIEF DESCRIPTION OF THE DRAWINGS

FIG. 1 illustrates a system according to one or more embodiments disclosed herein;

FIG. 2 illustrates a schematic view of a mobile device according to one or more embodiments disclosed herein;

FIG. 3 illustrates a flow chart depicting one or more methods disclosed herein;

FIG. 4A and FIG. 4B illustrate various user interfaces on a mobile device that allow an operator to select one or more optimization strategies according to one or more embodiments disclosed herein;

FIG. 5 illustrates an application specific data plan that provides the opportunity for a user to select one or more optimization strategies or policies on the mobile device in exchange for one or more plan, data, or user experience related incentives or perks;

FIG. 6 illustrates a user interface that allows a user to select one or more optimization strategies or policies on the mobile device in exchange for an incentive or perk that promotes non-peak period usage of the mobile device;

FIG. 7 illustrates a user interface that allows a user to select one or more optimization strategies or policies on the mobile device in exchange for an incentive or perk that promotes non-peak period usage of the mobile device;

FIG. 8 illustrates a system diagram according to one or more embodiments disclosed herein; and

FIG. 9 illustrates a protocol diagram according to one or more embodiments disclosed herein.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

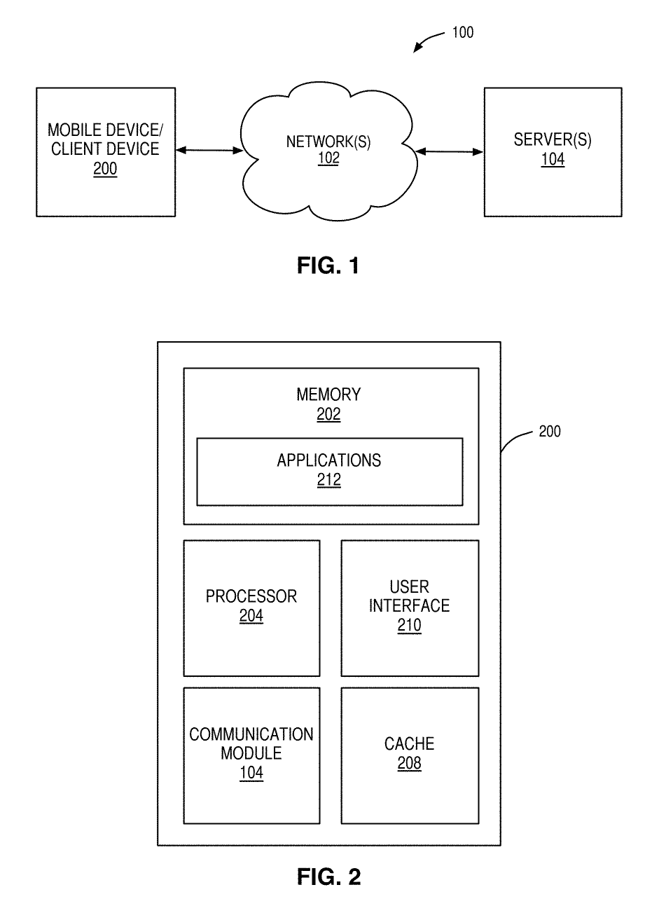

As illustrated in FIG. 1, a system 100 is provided. The system 100 includes a mobile device/client device 200, network(s) 102, and server(s) 104.

In general, the networks 102, over which the client devices 200, and servers 104 communicate, may be a cellular network, a broadband network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, UDP, HTTP, DNS, FTP, UPnP, NSF, ISDN, PDH, RS-232, SDH, SONET.

The networks 102 can be any collection of distinct networks operating wholly or partially in conjunction to provide connectivity to the client devices 200 and servers 104 and may appear as one or more networks to the serviced systems and devices. In one embodiment, communications to and from the client devices 200 can be achieved by, an open network, such as the Internet, or a private network, broadband network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), or any broadband network, and further enabled with technologies such as, by way of example, Global System for Mobile Communications (GSM), Personal Communications Service (PCS), Bluetooth, WiFi, Fixed Wireless Data, 2G, 2.5G, 3G, 4G, IMT-Advanced, pre-4G, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks, broadband networks, or messaging protocols.

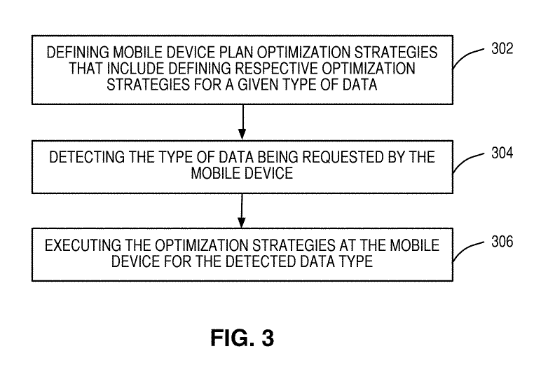

FIG. 2 depicts a block diagram illustrating an example of client-side components on a mobile device (e.g., wireless device) 200 that manages traffic in a wireless network (or broadband network) for resource conservation, content caching, and/or traffic management.

The device 200, which can be a portable or mobile device (e.g., any wireless device), such as a portable phone, generally includes, for example, a memory 202, applications 212 executing on the memory 202, a processor 204 for executing instructions from the applications 212, a user display 210 for displaying information from a user, and in embodiments where the user interface is a touch screen or other touch responsive device, receiving input from a user, a communications module 206 for communication with a network, and a cache 208. Other elements may be provided but are not shown in illustrated diagrams. One or more optimization strategies disclosed herein may be executed on the mobile device 200 with installation of an appropriate application. In other embodiments, the optimization strategies may be directed on a server side but control access by the mobile device 200.

Note that the device 200 is specifically illustrated in the example of FIG. 2 as a mobile device, such is not a limitation and that device 200 may be any wireless, broadband, portable/mobile or non-portable device able to receive, transmit signals to satisfy data requests over a network including wired or wireless networks (e.g., WiFi, cellular, Bluetooth, LAN, WAN, etc.).

The communications module 206 can be a networking module that enables the device 200 to mediate data in a network with an entity that is external to the host server 200, through any known and/or convenient communications protocol supported by the host and the external entity. The communications module 206 can include one or more of a network adaptor card, a wireless network interface card (e.g., SMS interface, WiFi interface, interfaces for various generations of mobile communication standards including but not limited to 2G, 3G, 3.5G, 4G, LTE, etc.,), Bluetooth, or whether or not the connection is via a router, an access point, a wireless router, a switch, a multilayer switch, a protocol converter, a gateway, a bridge, a bridge router, a hub, a digital media receiver, and/or a repeater.

Device 200 can further include, client-side components of the distributed proxy and cache system which can include, a local proxy (e.g., a mobile client of a mobile device) and the cache 208. In one embodiment, the local proxy includes a user activity module, a proxy API, a request/transaction manager, a caching policy manager having an application protocol module, a traffic shaping engine, and/or a connection manager.

As used herein, a “module,” “a manager,” a “handler,” a “detector,” an “interface,” a “controller,” a “normalizer,” a “generator,” an “invalidator,” or an “engine” includes a general purpose, dedicated or shared processor and, typically, firmware or software modules that are executed by the processor. Depending upon implementation-specific or other considerations, the module, manager, handler, detector, interface, controller, normalizer, generator, invalidator, or engine can be centralized or its functionality distributed. The module, manager, handler, detector, interface, controller, normalizer, generator, invalidator, or engine can include general or special purpose hardware, firmware, or software embodied in a computer-readable (storage) medium for execution by the processor.

As used herein, a computer-readable medium includes hardware (e.g., registers, random access memory (RAM), non-volatile (NV) storage, to name a few), but may or may not be limited to hardware.

The applications 210 and 220 can generally include any user application, widgets, software, HTTP-based application, web browsers, video or other multimedia streaming or downloading application, video games, social network applications, email clients, RSS management applications, application stores, document management applications, productivity enhancement applications, etc. The applications can be provided with the device OS, by the device manufacturer, by the network service provider, downloaded by the user, or provided by others.

The application 212 may be a part of the operating system or device platform or independent of the operating system, as illustrated. The operating system can include any operating system including but not limited to, any previous, current, and/or future versions/releases of, Windows Mobile, iOS, Android, Symbian, Palm OS, Brew MP, Java 2 Micro Edition (J2ME), Blackberry, etc.

The application 212 may be a plug-in to the operating system 204 or a particular client/application on the device 200. The application 212 can detect signals indicative of user or device activity, for example, sensing motion, gesture, device location, changes in device location, device backlight, keystrokes, clicks, activated touch screen, mouse click or detection of other pointer devices. The application 212 can be coupled to input devices or sensors on the device 200 to identify these signals. Such signals can generally include input received in response to explicit user input at an input device/mechanism at the device 200 and/or collected from ambient signals/contextual cues detected at or in the vicinity of the device 200 (e.g., light, motion, piezoelectric, etc.).

In one embodiment, the user activity module interacts with the context API 206 to identify, determine, infer, detect, compute, predict, and/or anticipate, characteristics of user activity on the device 200. Various inputs collected by the context application 212 can be aggregated by the user activity module to generate a profile for characteristics of user activity. Such a profile can be generated by the user activity module 215 with various temporal characteristics. For instance, user activity profile can be generated in real-time for a given instant to provide a view of what the user is doing or not doing at a given time (e.g., defined by a time window, in the last minute, in the last 30 seconds, etc.), a user activity profile can also be generated for a ‘session’ defined by an application or web page that describes the characteristics of user behavior with respect to a specific task they are engaged in on the device 200, or for a specific time period (e.g., for the last 2 hours, for the last 5 hours).

Additionally, characteristic profiles can be generated by the user activity module to depict a historical trend for user activity and behavior (e.g., 1 week, 1 mo., 2 mo., etc.). Such historical profiles can also be used to deduce trends of user behavior, for example, access frequency at different times of day, trends for certain days of the week (weekends or week days), user activity trends based on location data (e.g., IP address, GPS, or cell tower coordinate data) or changes in location data (e.g., user activity based on user location, or user activity based on whether the user is on the go, or traveling outside a home region, etc.) to obtain user activity characteristics.

In one embodiment, user activity module can detect and track user activity with respect to applications, documents, files, windows, icons, and folders on the device 200. For example, the user activity module can detect when an application or window (e.g., a web browser or any other type of application) has been exited, closed, minimized, maximized, opened, moved into the foreground, or into the background, multimedia content playback, etc.

In some embodiments, the application 212 is able to establish policies for choosing traffic (data, content, messages, updates, etc.). Additionally, by combining information from observing the application making the network requests, getting explicit information from the application, or knowing the network destination the application is reaching, the disclosed technology can determine or infer what category the transmitted traffic belongs to.

For example, in one embodiment, mobile or wireless traffic can be categorized as: (a1) interactive/foreground/active traffic or (a2) background traffic. The difference is that in (a1) a user is actively waiting for a response, while in (2) a user is not expecting a response. This categorization can be used in conjunction with or in lieu of a second type of categorization of traffic: (b1) immediate, (b2) low priority, (b3) immediate if the requesting application is in the foreground and active.

For example, a new update, message or email may be in the (b1) category to be delivered immediately, but it still is (a2) background traffic—a user is not actively waiting for it. A similar categorization applies to instant messages when they come outside of an active chat session. During an active chat session a user is expecting a response faster. Such user expectations are determined or inferred and factored into when optimizing network use and device resources in performing traffic categorization and policy implementation. Disclosed herein are one or more policies that may be selected by a user to optimize traffic based on many characteristics, including the categories described herein.

Some examples of the applications of the described categorization scheme, include the following: (a1) interactive traffic can be categorized as (b1) immediate—but (a2) background traffic may also be (b2) or (b3).

For example, a more advanced generation (e.g., 3G, LTE, or 4G or later) can be selected or specified for traffic when the activity state is in interaction with a user or in a foreground on the mobile device. Contrastingly, an older generation standard (e.g., 2G, 2.5G, or 3G or older) can be specified for traffic when one or more of the following is detected, the application is not interacting with the user, the application is running in the background on the mobile device, or the data contained in the traffic is not time critical, or is otherwise determined to have lower priority.

Similarly, a network configuration with a slower data rate can be specified for traffic when one or more of the following is detected, the application is not interacting with the user, the application is running in the background on the mobile device, or the data contained in the traffic is not time critical. The access channel (e.g., Forward access channel or dedicated channel) can be specified.

As referred to herein, the term “computing device” should be broadly construed. It can include any type of mobile device, for example, a smart phone, a cell phone, a pager, a personal digital assistant (PDA, e.g., with GPRS NIC), a mobile computer with a smart phone client, a portable media player device, a mobile gaming device, a tablet computer, a handheld computer, a laptop computer, set-top box, Internet radio, A/V network receiver, or the like. A computing device can also include any type of conventional computer, for example, a desktop computer or a laptop computer. A typical mobile device is a wireless data access-enabled device (e.g., an iPHONE® smart phone, a BLACKBERRY® smart phone, a NEXUS ONE™ smart phone, an iPAD™ device, Samsung Rogue smart phone, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes and/or small screen sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on a mobile device, the examples may similarly be implemented on any suitable computing device.

As referred to herein, an “interface” is generally a system by which users interact with a computing device. An interface can include an input for allowing users to manipulate a computing device, and can include an output for allowing the system to present information and/or data, indicate the effects of the user's manipulation, etc. An example of an interface on a computing device (e.g., a mobile device) includes a graphical user interface (GUI) that allows users to interact with programs in more ways than typing. A GUI typically can offer display objects, and visual indicators, as opposed to text-based interfaces, typed command labels or text navigation to represent information and actions available to a user. For example, an interface can be a display window or display object, which is selectable by a user of a mobile device for interaction. The display object can be displayed on a display screen of a mobile device and can be selected by and interacted with by a user using the interface. In an example, the display of the mobile device can be a touch screen, which can display the display icon. The user can depress the area of the display screen at which the display icon is displayed for selecting the display icon. In another example, the user can use any other suitable interface of a mobile device, such as a keypad, to select the display icon or display object. For example, the user can use a track ball or arrow keys for moving a cursor to highlight and select the display object.

Operating environments in which embodiments of the present disclosure may be implemented are also well-known. In a representative embodiment, a computing device, such as a mobile device, is connectable (for example, via WAP) to a transmission functionality that varies depending on implementation. Thus, for example, where the operating environment is a wide area wireless network (e.g., a 2.5G network, a 3G network, or 4G network), the transmission functionality comprises one or more components such as a mobile switching center (MSC) (an enhanced ISDN switch that is responsible for call handling of mobile subscribers), a visitor location register (VLR) (an intelligent database that stores on a temporary basis data required to handle calls set up or received by mobile devices registered with the VLR), a home location register (HLR) (an intelligent database responsible for management of each subscriber's records), one or more base stations (which provide radio coverage with a cell), a base station controller (BSC) (a switch that acts as a local concentrator of traffic and provides local switching to effect handover between base stations), and a packet control unit (PCU) (a device that separates data traffic coming from a mobile device). The HLR also controls certain services associated with incoming calls. Of course, the present disclosure may be implemented in other and next-generation mobile networks and devices as well. The mobile device is the physical equipment used by the end user, typically a subscriber to the wireless network. Typically, a mobile device is a 2.5G-compliant device or 3G-compliant device (or 4G-compliant device) that includes a subscriber identity module (SIM), which is a smart card that carries subscriber-specific information, mobile equipment (e.g., radio and associated signal processing devices), a user interface (or a man-machine interface (MMI), and one or more interfaces to external devices (e.g., computers, PDAs, and the like). The mobile device may also include a memory or data store.

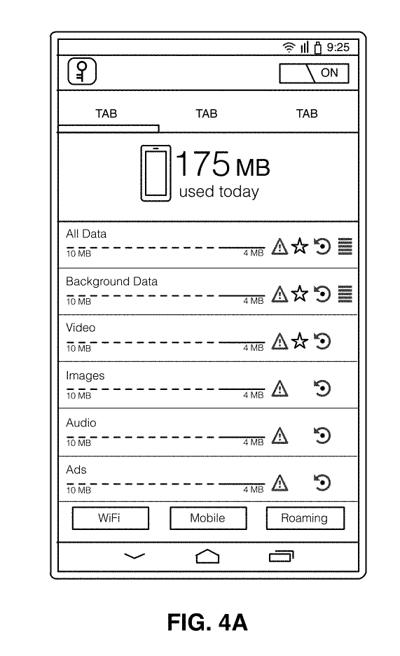

One or more methods 300 are disclosed herein and illustrated in the flow chart of FIG. 3.

The one or more methods may include defining, at a mobile device, mobile device plan optimization strategies 302. The mobile device plan optimization strategies may be defined by a user of the mobile device and may be customizable on a user-by-user basis. The strategies may take many factors into consideration when developing a strategy including the type of data requests being made (foreground versus background, high bandwidth consuming video or audio compared to low-bandwidth text or message data, time of day, consumption of data in a given data plan, and other details as described herein). In one or more embodiments, the optimization strategies include defining respective optimization strategies for a given type of data. In this manner, video data may have a different optimization strategy than text data.

The method 300 may further include detecting the type of data being requested by the mobile device 302.

Detecting the type of data being requested may include comparing pattern matching requests or content types to known file formats and known fingerprints of advertise to determine the type of data being requested.

Detecting the type of data being requested may include comparing pattern matching response headers to known file formats or known fingerprints of advertisements to determine the type of data being requested.

Detecting the type of data being requested may include identifying applications that are known to perform specific actions to determine the type of data being requested.

Detecting the type of data being requested may include managing known file formats and known fingerprints

Detecting the type of data being requested may include observing the received content while not restricting the traffic.

Detecting the type of data being requested may include any combination of the methods disclosed herein.

The method 300 may further include executing the optimization strategies at the mobile device for the detected data type 306. This method may be executed by processor 204 operating on mobile device 200 as described herein.

The strategies deployed herein include basing the strategies on various usage thresholds for a mobile device data plan. For example, a first optimization policy may restrict or otherwise optimize data content requests at a first threshold of mobile device data plan usage, such as, for example, restricting viewing of video files longer than a certain length or having a bandwidth usage greater than a certain amount when plan data usage has exceeded 60% for a given billing cycle. In this manner, the strategies are based on various usage thresholds for a mobile device usage plan. At, for example, the point where the plan data usage has exceeded 80% for a given billing cycle, then all video files may be restricted or otherwise blocked from being viewed at the mobile device 200. The strategies may include optimizing based on the destination address. For example, the user could direct the application to optimize traffic from certain addresses while not optimize traffic from other addresses.

The optimization strategies may be applicable for rate optimizing data usage when a mobile device 200 is roaming outside of the subscription carrier's network.

The optimization strategies may include strategies based on various usage thresholds for a period of time. The period of time may be less than a full length of a billing period. In this manner, data usage on a per day basis may be monitored. For example, a per rata usage threshold per day may be determined for a given data plan. The operator can be alerted and otherwise have data usage optimized if data usage in any given day exceeds a determined threshold. This process would necessarily also detect any abnormal data usage on a mobile device due to, for example, a recent install of a new application that the user may have been unaware would have heavy data usage, particularly if such application is in the background and doesn't otherwise indicate activity to a user.

Additionally, this per rata usage threshold would allow a parent or owner of the mobile device to set optimization strategies for a mobile device being used by a minor. For example, if a parent wanted to limit the amount of data viewed by a minor operating the mobile device 200, the parent could select a setting that limited the amount of data that can be accessed a given day, much like limiting the amount of television that a minor can watch. In this optimization strategy, access to audio and video data may be blocked or otherwise restricted at a certain threshold, however, messaging and text data could still be received.

The optimization strategies may include, after the mobile device 200 has exceeded a first threshold data usage, the strategies cause the mobile device 200 to compress or decrease quality of videos and images before receipt at the device. This may be accomplished by the mobile device 200 requesting to the server(s) 104 a lower quality data transmission.

The optimization strategies may be application specific. For example, the user may direct the mobile device 200 to block or otherwise optimize video data being requested by a social networking application on the mobile device 200 but may otherwise allow without optimization video data being requested by a work-related email application. In this manner, the user can select optimization strategies that prioritize mobile data usage based on the priority of the applications requesting data usage. And the application specific optimization strategies could be invoked after a certain data usage threshold.

The optimization strategy may further include selecting optimization strategies that are dependent on the type of network being accessed. For example, if the mobile device 200 is operating in a 2G or lesser quality network, the user may select an optimization strategy that optimizes or otherwise blocks video data because user experience is likely low with a slow network connection.

The optimization strategies may include different strategies for different periods in a billing cycle. For example, the operator of the mobile device 200 may decide to pace or otherwise monitor data usage during the first half of a billing cycle. In this manner, the data usage is optimized in the first half of the billing cycle and once it is determined that sufficient data remains for the remainder of the billing cycle, a different optimization strategy is employed.

In one or more embodiments, the mobile device 200 is configured to allow a user to disable the strategies for a period of time. The data usage strategy could be partially dynamic and partially user specified. For example, the user may direct that certain data usage thresholds begin an optimization strategy, and within those thresholds, the optimization strategy may be dynamically controlled by the application 212.

Detecting the type of date being requested by the mobile device may include comparing pattern matching requests or requested content types to known file formats and known fingerprints of advertisements to determine the type of data being requested.

Detecting the type of date being requested by the mobile device may include comparing pattern matching response headers to known file formats or known fingerprints of advertisements to determine the type of data being requested.

Detecting the type of date being requested by the mobile device may include identifying applications that are known to perform specific actions to determine the type of data being requested, managing known file formats and known fingerprints offline.

Detecting the type of date being requested by the mobile device may include observing the received content while not restricting the traffic.

Detecting the type of date being requested by the mobile device may include any combination of the methods disclosed herein.

The optimization strategies may include one increasing compression of video and image data requested at the mobile device.

The optimization strategies may include pacing download of video data to playback of video data. In this manner, the portion of the video that is downloaded is only incrementally beyond that which has been used by the user. In this case, if the user does not watch the entire video, then only that which is necessary will have been viewed. This may include requesting partial data from the content server.

The optimization strategies may include restricting or blocking of application downloads, application updates, or service pack installations.

The optimization strategies may include one of decreasing quality levels of video and image data requested at the mobile device.

The optimization strategies may include one of restricting or blocking video data requested at the mobile device.

The optimization strategies may include one of restricting or blocking image data requested at the mobile device.

The optimization strategies may include one of restricting or blocking data requests from applications executing in the background.

The optimization strategies may include one of restricting or blocking data indicative of advertisement data.

The optimization strategies may include one of restricting or blocking audio data. The optimization strategies may include one of restricting or blocking all data.

The optimization strategies may include any combination of the methods disclosed herein.

According to one or more embodiments, the optimization strategies include a first strategy for background applications and a second strategy for foreground applications. In this manner, impact on user experience due to the optimization strategies is minimized as active/foreground actions by the user may not trigger optimization strategies or may trigger optimization strategies with the least amount of user experience impact, while background actions may be optimized with little impact on user experience.

The optimization strategies are defined for specific time periods during a day. For example, a user may provide optimization strategies during working hours because the user device is not likely to be actively used during working hours and user experience will not likely be impacted.

According to one or more embodiments, the optimization strategies may include restricting or blocking dormant applications. The methods further include detecting a dormant application by one of: determining that an application has not been used in the foreground for a period of time or determining that traffic has not had traffic patterns that match active use for a period of time. The patterns may include, in the situation where an application serves other applications, observing traffic or usage of those applications to determine if the first application is still active. This could be further based on either offline knowledge, or registration of the first application to use the second application for background data transfer. Additionally, some applications use specific ports or protocols (like HTTP or port 80) for active traffic and other protocols or ports for non-active traffic) and this could be monitored.

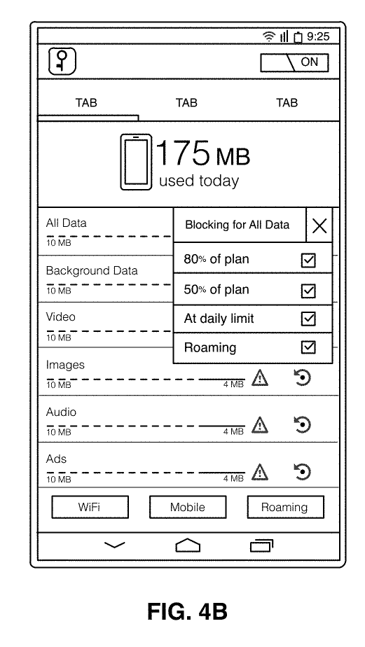

FIGS. 4A and 4B illustrate an example user interface that may be employed on the mobile device 200. As illustrated, the application may display on the user interface a listing of the type of data being used. For example, all data, background data, video, images, audio, and Ad related data is shown. A capacity indicator is illustrated that shows the amount of data used. Beside each indicator is a drop down menu (see FIG. 4B) that will allow the user to direct when to block or otherwise optimize data. For example, if the user wants to optimize all data once 80% of a certain threshold is used, the user selects “Blocking for All Data” at 80% of plan. Alternatively, if optimization is desired to occur at 50%, the user selects the 50% threshold. The user may also select that specific data is blocked. For example, the user might determine that all video data should be blocked when data usage is 60% of device usage plan, whereas, the user might not want for image data to be blocked until data usage is 80% of that device usage plan. In this manner, the optimization of certain data may vary depending on the total data usage of the device usage plan.

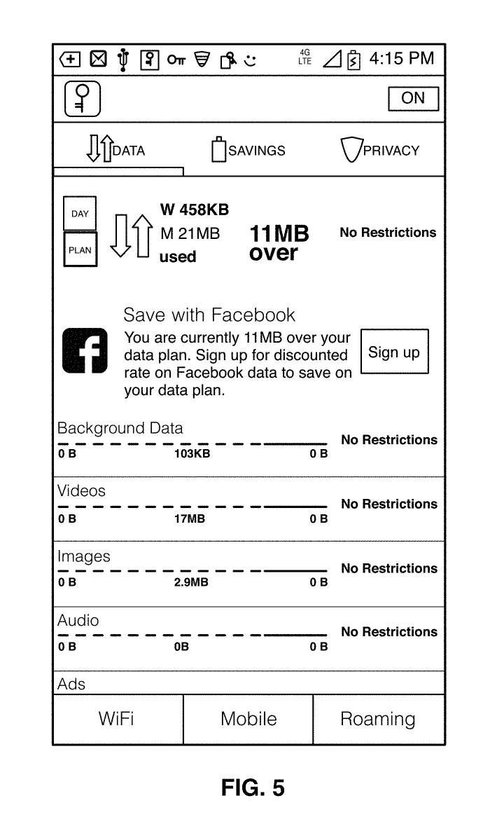

FIG. 5 illustrates an application of intelligent data plan management. In one embodiment, systems and methods may he provided that allow collaboration of a data management policy between the end user and the service provider, so that the service provider can offer benefits/lessening policy control, by, for example in one or more embodiments, providing additional data allowance, lower price, higher speed, free data for specific applications or sites, and the like in exchange for the user to agree on certain data plan management measures, which in one or more embodiments may include slowing down transfer speeds and/or blocking certain types of data at specific events, which could be data plan related, such as exceeding a proportion of data plan, or daily allowance, or related to the network, such as congestion, network at, near or over capacity temporarily in real terms, or estimated to be (for example, during peak hours of the day). One or more congestion triggers may be provided by the network or detected by the mobile device. The congestion triggers may be triggered when too many mobile devices are in a cellular block, network, or other space, or too much bandwidth being consumed at a given time or at a given rate, or too much of a certain type of data being accessed.

As illustrated in FIG. 5, an application can be provided on the mobile device for a user to access and understand their data usage relative to their plan and in total. The application user interface may include indicators for the types of data being used. The user interface may be touch responsive and allow a user to select to sign up for a user-selected savings plan. In exchange, the network provider may offer additional data within the plan term. In one or more embodiments, a user may be able to use the additional data to offset a data or service overage. Alternatively, instead of an application based input system, a web-based browser or module may be provided for the user to log in to utilize the same functionality.

In one or more embodiments, the intelligent data plan management can include not only blocking data and compressing data, that may further include lossy or lossless compression mechanisms, but also mechanisms that eventually transfer the same data but have lower resource demands from the network, such as lowering the speed of transfer, or using less congested network technology, or delaying the transfer. One example may be allowing application upgrades only during night time or when demand is likely low.

In one or more embodiments, mechanisms in intelligent data plan management can be managed by a program on the device that uses various optimization techniques such as blocking requests, receiving data slower causing network to slow down, switching between network technologies, delaying specific request types, or by a program in the network that uses various optimization techniques such as blocking requests, sending data slower to the device, switching between network technologies, delaying responses to certain request types, or a combination of the two such as a program in the device indicating to the network to slow down sending data to the device.

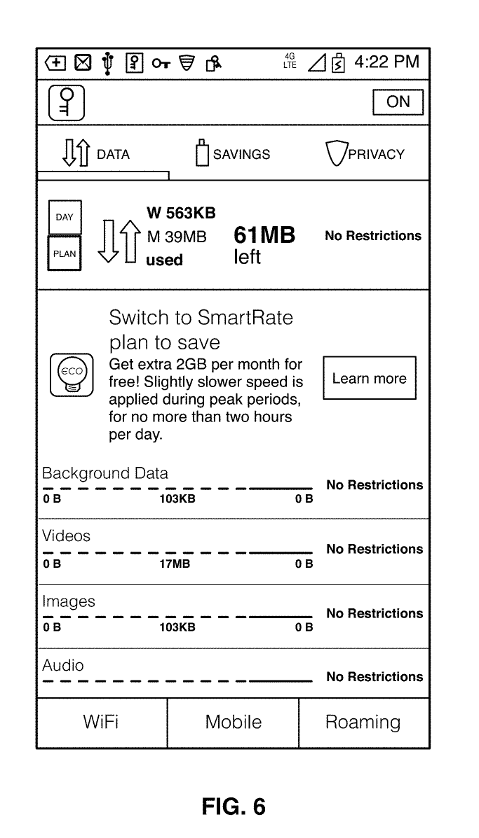

As illustrated in FIG. 6, the application can be provided on the mobile device for a user to access and understand their data usage relative to their plan and in total. In the embodiments illustrated in FIG. 6, non-peak usage is promoted through use of the application. As illustrated, the user may be able to select an optimization strategy that allows for slower upload or download speeds during peak hours in exchange for additional data within the plan.

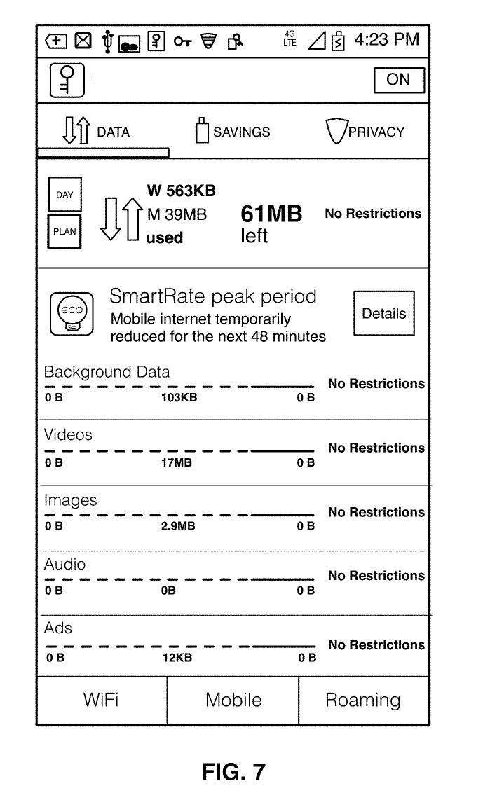

As illustrated in FIG. 7, when the optimization strategy of FIG. 6 is employed, an indication may be provided to the user that they will have slightly reduced internet speeds for a period of time.

The application may be configured to display a message to the user when the user is either approaching their data usage limit or has exceeded the limit or using an unusually or unsustainable amount of data. The message may then prompt the user to select whether they will activate the optimization strategy. Alternatively, the message may be displayed when another trigger is engaged, such as network congestion detected by either the mobile device or network or server.

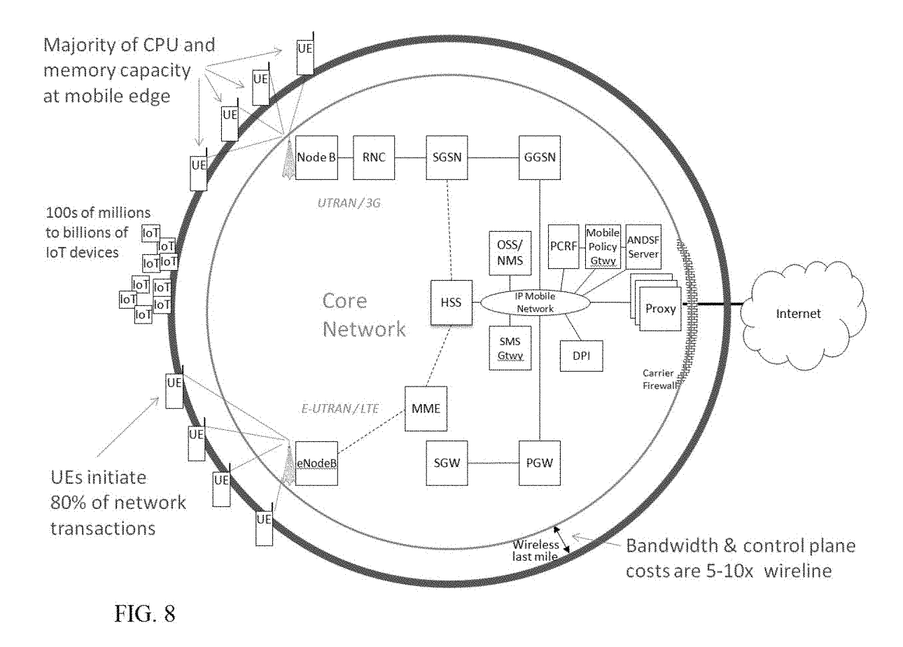

The one or more systems disclosed herein and illustrated in FIG. 8 may be configured to move the functions of the network switch to the end point, which is the mobile device in this example, and perform many of the switching functions already at the end point. These one or more functions may include routing, changing ports, modifying IP, TCP, UDP etc. packet header fields according to routing and filtering rules set by a controller function (which could be set by one or more policy mechanisms, for example).

One or more embodiments disclosed herein would be to make the routing in the end points compatible with software defined networking (SDN) mechanisms, such as OpenFlow.

Extending from there, the one or more systems disclosed herein can also move functions from the network to the mobile device, specifically PCEF and DPI (Deep Packet Inspection). This advantageously provides for releasing capital expenditure on the network. Also, with the “DPI at the end point”, some of the DPI functionality (such as Application Detection and Control) can be done easier in the mobile device as it can have direct information about the application, instead of DPI, where it is being second-guessed.

As used herein, PCEF refers to Policy and Charging Enforcement Function. The policy control actions include, for example, Subscriber session authorization and management, Service selection and personalization, Quality of service (QoS) and bandwidth control, for example, for Voice over LTE (VoLTE) and video calls, and Session- and application-specific quota authorization and tracking.

In one or more embodiments, charging actions could include implementation of Online Charging Services (OCS) with real-time rating rules, or offline charging services.

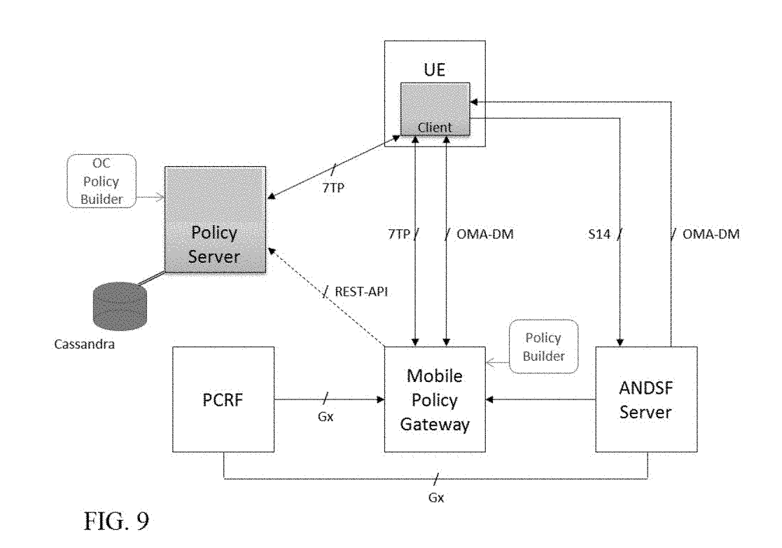

The function (e.g. PCEF, DPI) at the end point may communicate with the network elements with existing Gx, Gy and Sd (among other) interfaces, or it may be advantageous to deploy a wireless policy server in between, as these interfaces were not designed to be communicated over the wireless network. An example of such setup is in FIG. 9.

7TP as illustrated in FIG. 9 is a wireless-optimized protocol for, among others, to communicate policies to the mobile device (disclosed in the PMS application). Other mechanisms, such as OMA DM (Open Mobile Alliance Device Management) can be utilized as well.

Further advantages of moving DPI/PCEF/other functionality to the end point include broader coverage across networks, as it may not be possible to have PCEF/DPI/etc. present at each network routing point (e.g. home Wi-Fi), location-awareness, as the end-point is aware of its own location in higher granularity than any of the network elements. This would allow policies, charging and DPI functionalities that are location-specific, and user notifications—with direct access to user equipment, the end point can provide more user friendly notifications of policy/charging actions and involve user into such decisions for, for example, upselling opportunities for a network provider.

Additionally, DPI functionality may include TDF (Traffic Detection Function) in addition to ADC.

The application may be configured to display a message to the user when the user is either approaching their data usage limit or has exceeded the limit or using an unusually or unsustainable amount of data. The message may then prompt the user to select whether they will activate the optimization strategy. Alternatively, the message may be displayed when another trigger is engaged, such as network congestion detected by either the mobile device or network or server.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the presently disclosed subject matter. In the case of program code execution on programmable computers, the computer will generally include a processor, a storage medium readable by the processor (including volatile and non-volatile memory and/or storage elements), at least one input device and at least one output device. One or more programs may be implemented in a high level procedural or object oriented programming language to communicate with a computer system. However, the program(s) can be implemented in assembly or machine language, if desired. In any case, the language may be a compiled or interpreted language, and combined with hardware implementations.

The described invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the presently disclosed subject matter. When implemented on a general-purpose processor, the program code combines with the processor to provide a unique apparatus that operates to perform the processing of the presently disclosed subject matter.

Features from one embodiment or aspect may be combined with features from any other embodiment or aspect in any appropriate combination. For example, any individual or collective features of method aspects or embodiments may be applied to apparatus, system, product, or component aspects of embodiments and vice versa.

What is claimed is:

1. A method comprising:
defining, at a mobile device, mobile device plan optimization strategies, wherein the optimization strategies include defining respective optimization strategies for a given type of data;
detecting the type of data being requested by the mobile device; and
executing the optimization strategies at the mobile device for the detected data type.
